(19) United States
(12) Patent Application Publication
(10) Pub. No.: US 2018/0100662 A1
(43) Pub. Date: Apr. 12, 2018

(54) Method for Data-Driven Learning-based Control of HVAC Systems using High-Dimensional Sensory Observations

(71) Applicant: Mitsubishi Electric Research Laboratories, Inc., Cambridge, MA (US)

(72) Inventors: Amir-massoud Farahmand, Cambridge, MA (US); Saleh Nabi, Arlington, MA (US); Piyush Grover, Somerville, MA (US); Daniel Nikolaev Nikovski, Brookline, MA (US)

(73) Assignee: Mitsubishi Electric Research Laboratories, Inc., Cambridge, MA (US)

(21) Appl. No.: 15/290,038

(22) Filed: Oct. 11, 2016

(51) Int. Cl. F24F 11/00; G05B 19/042; G06N 99/00

(52) U.S. Cl. CPC F24F 11/006; F24F 11/001; G05B 19/0428; G05B 2219/2614; F24F 2011/0064; F24F 2011/0057; G06N 99/005

(57) ABSTRACT

A controller for controlling an operation of an air-conditioning system conditioning an indoor space includes a data input to receive state data of the space at multiple points in the space, a memory to store a code of a reinforcement learning algorithm and a history of the state data and a history of control commands having been applied to the air-conditioning system, wherein the history of the control commands is associated with the state data and history of rewards, a processor coupled to the memory determines a value function outputting a cumulative value of the rewards and transmits a control command by using the reinforcement learning algorithm, and a data output to receive the control command from the processor and transmit a control signal to the air-conditioning system, wherein the control signal controls at least one actuator of the air-conditioning system according to the control command.

### FIELD OF THE INVENTION

This invention relates to a method for controlling an HVAC system, and an HVAC control system, more specifically, to a reinforcement learning-based HVAC control method and an HVAC control system thereof.

### BACKGROUND OF THE INVENTION

A heating ventilation and air conditioning (HVAC) system has access to multitude of sensors and actuators. The sensors are thermometers at various locations in the building, or infrared cameras that can read the temperature of the people, objects, and walls in the room. Further, the actuators in an HVAC system are fans blowing airs and controlling the speed of airs to control the temperature in a room. The ultimate goal of the HVAC system is to make occupants feel more comfortable while minimizing the operation cost of the system.

The comfort level of an occupant depends on many factors including the temperature, humidity, and airflow around the occupant in the room. The comfort level also depends on the body's core temperature and other physiological and psychological factors that affect the perception of comfort. There are external and internal factors with complex behaviors. The external factors depend on the temperature and humidity of the airflow, and can be described by the coupling of the Boussinesq or Navier-Stokes equation and the advection-diffusion equations. These equations are expressed by partial differential equations (PDE) describing the momentum and the mass transportation of the airflow and the heat transfer within the room. The physical model of the airflow is a complex dynamical system, so modeling and solving the dynamical system in real-time is very challenging. Since the governing equations of the airflow are expressed by PDEs, the temperature and humidity are not only time varying, but also spatially-varying. For example, the temperature near windows during winters is lower than that of a location apart from the windows. So a person sitting close to a window might feel uncomfortable even though the average temperature in the room is within a standard comfort zone.

The dynamics of internal factors is complex too, and depends on the physiology and psychology of an individual, and thus is individual-dependent. An ideal HVAC system should consider the interaction of these two internal and external systems. Because of the complexity of the systems, designing an HVAC controller is extremely difficult.

Current HVAC systems ignore these complexities through a series of restrictive and limiting approximations. Most approaches used in the current HVAC systems are based on the lumped modeling of all relevant physical variables indicated by only one or a few scalar values. This limits the performance of the current HVAC systems in making occupants comfortable while minimizing the operation cost because the complex dynamics of the airflow, temperature, and humidity change are ignored.

Accordingly, further developments of controlling the HVAC systems are required.

### SUMMARY OF THE INVENTION

Some embodiments are based on recognition and appreciation of the fact that a controller for operating an air-conditioning system conditioning an indoor space includes a data input to receive state data of the space at multiple points in the space; a memory to store a code of a reinforcement learning algorithm and a history of the state data and a history of control commands having been applied to the air-conditioning system, wherein the history of the control commands is associated with the state data and history of rewards; a processor coupled to the memory determines a value function outputting a cumulative value of the rewards and transmits a control command by using the reinforcement learning algorithm, wherein the reinforcement learning algorithm processes the histories of the state data, control commands, and reward data and transmits a control command; a data output to receive the control command from the processor and transmit a control signal to the air-conditioning system, wherein the control signal controls at least one actuator of the air-conditioning system according to the control command.

Another embodiment discloses a controlling method of an air-conditioning system conditioning an indoor space. the controlling method includes steps of measuring, by using at least one sensor, state data of the space at multiple points in the space; storing a history of the state data and a history of control commands having been applied to the air-conditioning system, wherein the history of the control commands is associated with the state data and history of rewards; determining a value function outputting a cumulative value of the rewards, wherein the determining the value function is performed by using a reinforcement learning algorithm that processes the histories of the state data, control commands, and reward data and transmits a control command; determining a control command based on the value function using latest state data and the history of the state data; and controlling the air-conditioning system by using at least one actuator according to the control command.

Another embodiment discloses air-conditioning system conditioning an indoor space. The air-conditioning system includes at least one sensor configured to measure state data of the space at multiple points in the space; an actuator control device comprises: a compressor control device configured to control a compressor; an expansion valve control device configured to control an expansion valve; an evaporator fan control device configured to control an evaporator fan, a condenser fan control device configured to control a condenser fan; and a controller configured to transmit a control command to the actuator control device, wherein the controller comprises: a data input to receive state data of the space at multiple points in the space; a memory to store a code of a reinforcement learning algorithm and a history of the state data and a history of control commands having been applied to the air-conditioning system, wherein the history of the control commands is associated with the state data and history of rewards; a processor coupled to the memory determines a value function outputting a cumulative value of the rewards and transmits a control command by using the reinforcement learning algorithm, wherein the reinforcement learning algorithm processes the histories of the state data, control commands, and reward data and transmits a control command; a data output to receive the control command from the processor and transmit a control signal to the air-conditioning system, wherein the control signal controls at least one actuator of the air-conditioning system according to the control command.

Another embodiment discloses a non-transitory computer readable recoding medium storing thereon a program having instructions, when executed by a computer, the program causes the computer to execute the instructions for controlling an air-conditioning system air-conditioning an indoor space, the instructions comprising steps of: measuring, by using at least one sensor, state data of the space at multiple points in the space; storing a history of the state data and a history of control commands having been applied to the air-conditioning system, wherein the history of the control commands is associated with the state data and history of rewards; determining a value function outputting a cumulative value of the rewards, wherein the determining the value function is performed by using a reinforcement learning algorithm that processes the histories of the state data, control commands, and reward data and transmits a control command; determining a control command based on the value function using latest state data and the history of the state data; and controlling the air-conditioning system by using at least one actuator according to the control command.

### BRIEF DESCRIPTION OF THE DRAWINGS

FIG. 1A is a block diagram of an air-conditioning system;

FIG. 1B is a schematic of a room controlled by the air-conditioning system;

FIG. 2A is a block diagram of control processes of a controller of an air-conditioning system;

FIG. 2B is a block diagram of a reinforcement learning agent interacting with environments;

FIG. 2C shows a reinforcement learning process and a computer system processing an RFQI algorithm for controlling an HVAC system;

FIG. 3 shows different states of a room indicated as a caricature of hot and cold areas;

FIG. 4 shows a comparison of two thermal states of a room;

FIG. 5 is a flowchart of an RFQI algorithm;

FIG. 6 shows an RFQI algorithm comparing the current state of a room with a database for selecting an action; and

FIG. 7 shows a block diagram for determining a reward function.

### DETAILED DESCRIPTION OF THE PREFERRED EMBODIMENTS

Various embodiments of the present invention are described hereafter with reference to the figures. It would be noted that the figures are not drawn to scale elements of similar structures or functions are represented by like reference numerals throughout the figures. It should be also noted that the figures are only intended to facilitate the description of specific embodiments of the invention. They are not intended as an exhaustive description of the invention or as a limitation on the scope of the invention. In addition, an aspect described in conjunction with a particular embodiment of the invention is not necessarily limited to that embodiment and can be practiced in any other embodiments of the invention.

Some embodiments are based on recognition that controller for controlling an operation of an air-conditioning system conditioning an indoor space, includes a data input to receive state data of the space at multiple points in the space; a memory to store a code of a reinforcement learning algorithm and a history of the state data and a history of control commands having been applied to the air-conditioning system, wherein the history of the control commands is associated with the state data and history of rewards; a processor coupled to the memory determines a value function outputting a cumulative value of the rewards and transmits a control command by using the reinforcement learning, wherein the reinforcement learning processes the histories of the state data, control commands, and reward data and transmits a control command; a data output to receive the control command from the processor and transmit a control signal to the air-conditioning system, wherein the control signal controls at least one actuator of the air-conditioning system according to the control command.

The history of the states can be a sequence of observations of the states of the space and control commands over time that is a history of the system.

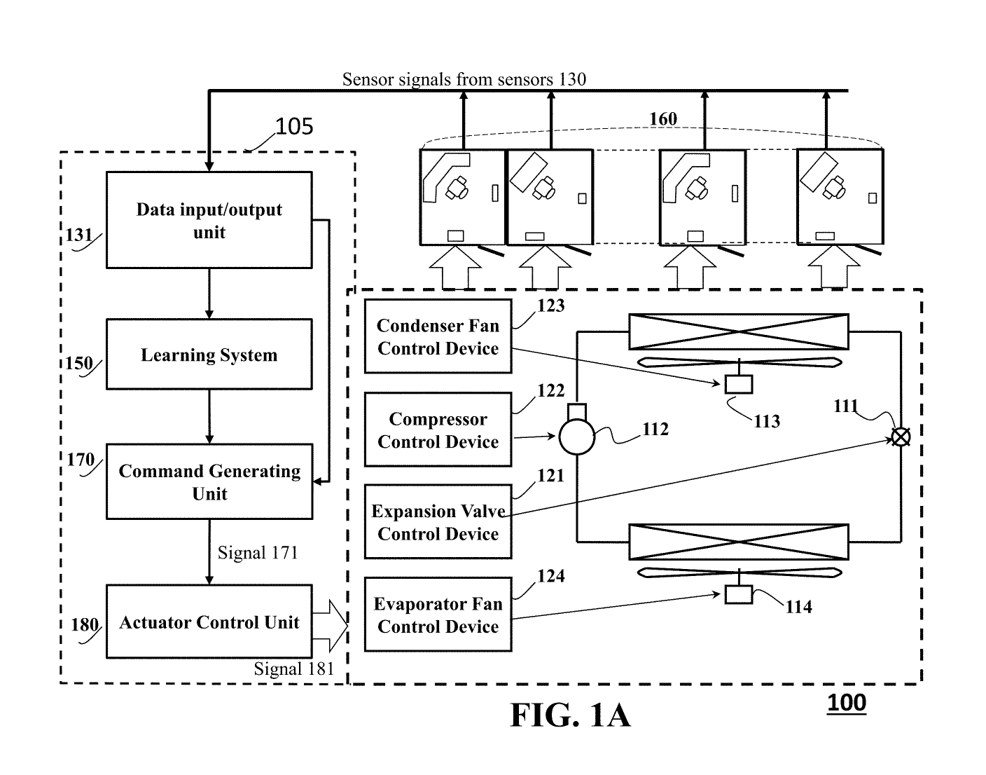

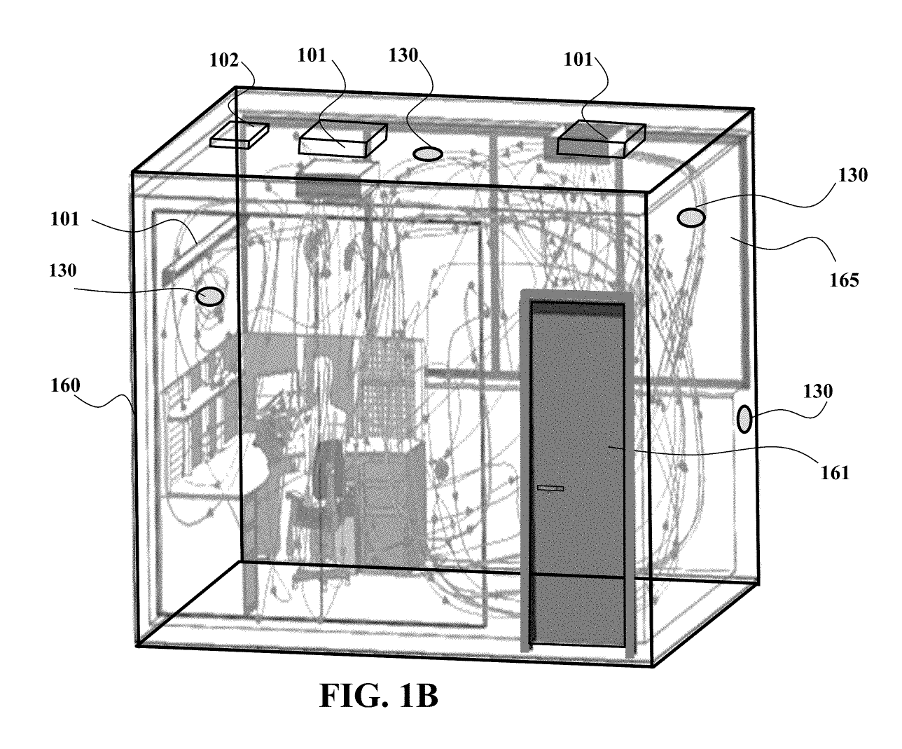

FIG. 1A shows a block diagram of an air-conditioned system in rooms. The air-conditioned system may be referred to as an HVAC system 100. The HVAC system includes a controller 105, a compressor control device 122, an expansion valve control device 121, an evaporator fan control device 124, and a condenser fan control device 123. These devices are connected to one or a combination of components such an evaporator fan 114, a condenser fan 113, an expansion valve 111, and a compressor 112.

Further, FIG. 1B shows a schematic of an air-conditioned room. In this case, each of the rooms 160 has one or more doors 161, windows 165 and walls separating neighboring rooms. The temperature and airflow of the room 160 is controlled by the HVAC system 100 through ventilation units 101 arranged on the ceiling of the room 160. In some cases, the ventilation units 101 can be arranged on the walls of the room 160. Each ventilation unit 101 may include fans changing the airflow directions by changing the angles of the fans. In this case, the angles of the fans can be controlled by signals from the controller 105 connected to the HVAC system 100. In some cases, the ventilation unit 101 includes airflow deflectors attached to the fans changing the airflow directions controlled by the signals from the controller 105 connected to the HVAC system 100. A set of sensors 130 are arranged on the walls of the room 160 and provide physical information to the controller 105. Further, the sensors 130 observe or measure states of the HVAC system 100.

The controller 105 includes a data input/output (I/O) unit 131 transmitting and receiving signals from sensors 130 arranged in the room 160, the learning system 150 including a processor and a memory storing code data of a learning algorithm (or learning neural networks), a command generating unit 170 determining and transmitting a control signal 171, an actuator control unit 180 receiving the command signal 171 from the command generating unit 170 generates and transmits a control command 181 to the actuators of the HVAC system 100. The actuators may include a compressor control device 122, an expansion valve control device 121, a condenser fan control device 123, and an evaporator fan control device 124.

In some embodiments of the invention, the sensors 130 can be infrared (IR) cameras that measure the temperatures over surfaces of objects arranged in the room or another indoor space. The IR cameras are arranged on the ceiling of the room 160 or the walls of the room 160 so that the IR cameras can cover a predetermined zone in the room 160. Further, each IR camera can measure and record temperature distribution images over the surfaces of the objects in the room in every predetermined time. In this case, the predetermined time can be changed according to a control command transmitted from the controller 105 of the HVAC system 100. Further, the sensors 130 can be temperature sensors to detect temperatures on the surface of an object in the room, and transmit signals of the temperatures to the HVAC system 100. Also, the sensors can be humidity sensors detecting humidity at predetermined spaces in the room 160 and transmit signals of the humidity to the HVAC system 100. The sensors 130 can be airflow sensors measuring airflow rate at predetermined positions in the room 160 and transmit signals of the airflow rates measured to the HVAC system 100.

The HVAC system 100 may include other sensors scattered in the room 160 for reading the temperature, humidity, and airflow around the room 160. Sensor signals transmitted from the sensors 130 to the HVAC system 100 are indicated in FIG. 1A. Further, the sensors 130 may be arranged at places other than the ceiling or walls of the room. For instance, the sensors 130 may be disposed around any objects such as tables, desks, shelves, chairs or sofas in the room 160. Further, the objects may be a wall forming the space of the room or partitions partitioning zones of the room.

In some cases, the sensors 130 include microphones arranged at predetermined locations in the in the room 160 to detect occupant's voice. The microphones are arranged zones in the room 160, in which the zone are close to the working position of the occupant. For instance, the predetermined locations can be a working desk, a meeting table, chairs, walls or partitioning walls arranged around the desks or tables. The sensors 130 can be wireless sensors that communicate with the controller 105 via the data input/output unit 131.

In another embodiment, the other types of settings can be considered, for example a room with multiple HVAC units, a multi-zone office, or a house with multiple rooms.

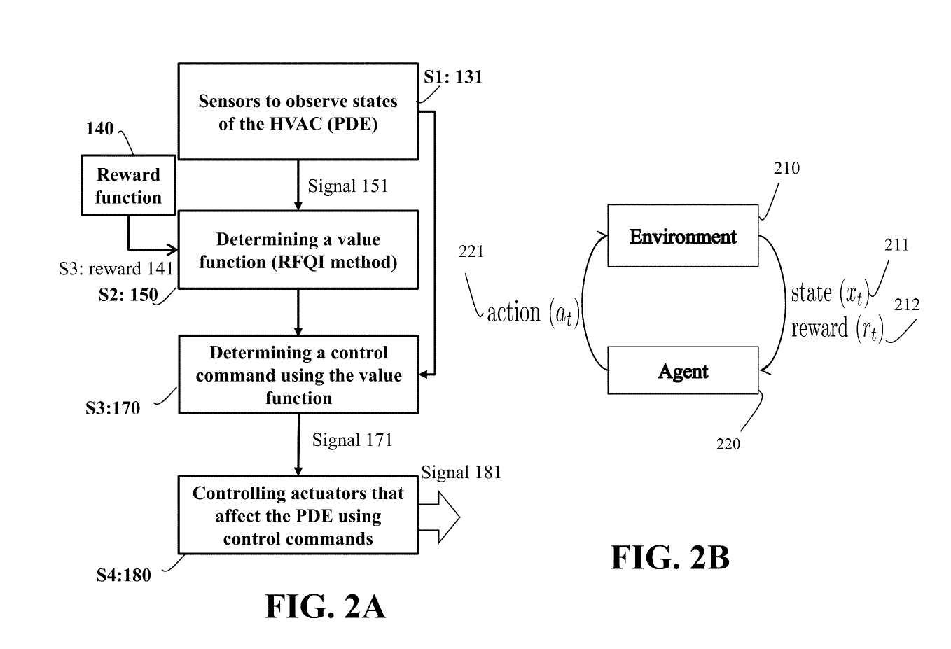

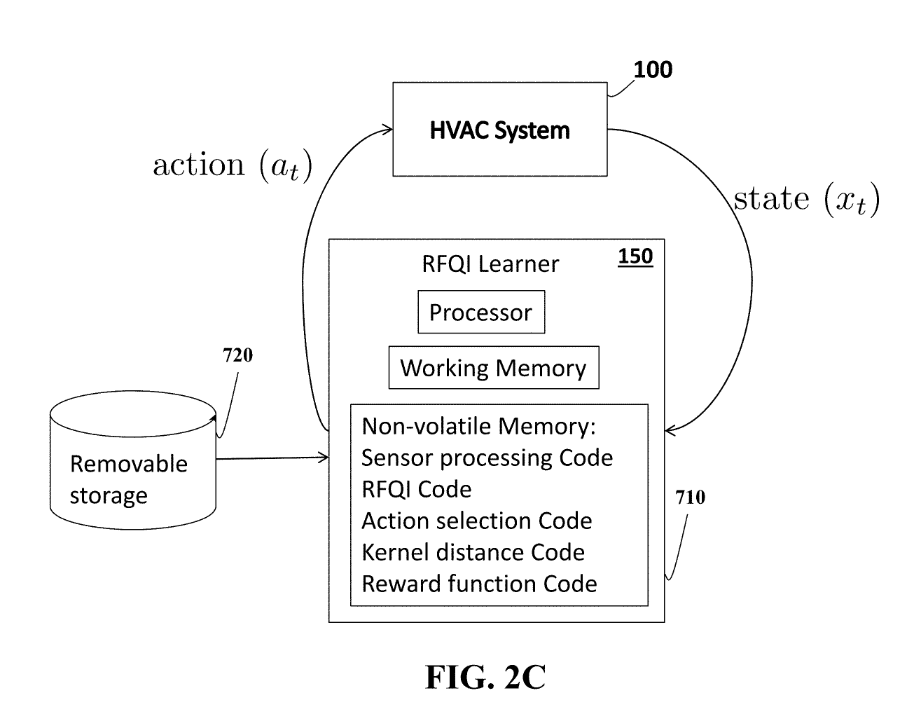

FIG. 2A is a block diagram of control processes of the controller 105 of an air-conditioning system 100. In step S1, the controller 105 receives signals from the sensors 130 via the data input/output (I/O) unit 131. The data I/O unit 131 includes a wireless detection module (not shown in the figure) that receives wireless signals from wireless sensors included in the sensor 130 or wireless input devices installed in a wireless device used by an occupant.

The learning system 150 includes a reinforcement learning algorithm stored in the memory in connection with the processor in the learning system 150. The learning system 150 obtains a reward from a reward function 140. In some cases, the reward value can be determined by a reward signal (not shown in figure) from the wireless device 102 receiving a signal from a wireless device operated by an occupant. The learning system 150 transmits a signal 151 to the command generating unit 170 in step S2.

After receiving the signal, the command generating unit 170 generates and transmits a signal 171 to the actuator control unit 180 in step S3. Based on the signal 171, the actuator control unit 180 transmits a control signal 181 to the actuators of the air-conditioning system 100 in step S4.

The reward function 140 provides a reward 141. The reward 141 can be positive whenever the temperature is within the desired limits, and can be negative when it is not. This reward function 140 can be set using mobile applications or an electronic device on the wall. The learning system 150 observes the sensors 130 via the data I/O unit 131 and collects data from the sensors 130 at predetermined regular times. The learning system 150 is provided a dataset of the sensors 130 through the observation. The dataset is used to learn a function that provides the desirability of each state of the HVAC system. This desirability is called the value of the state, and will be formally defined. The value is used to determine the control command (or control signal) 171. For instance, the control command is to increase or decrease the temperature of the air blown to the room. Another control command is to choose specific valves to be opened or closed. These high-level control commands are converted to lower-level actuator controlling signals 181 on a data output (not shown in the figure). This controller is operatively connected to a set of control devices for transforming the set of control signals into a set of specific control inputs for corresponding components.

For example, the controller unit 180 in the controller 105 can control actuators including the compressor control device 122, the expansion valve control device 121, the evaporator fan control device 124, and the condenser fan control device 123. These devices are connected to one or a combination of components such the evaporator fan 114, the condenser fan 113, the expansion valve 111, and the compressor 112.

In some embodiments according to the invention, the learning system 150 can use a Reinforcement Learning (RL) algorithm stored in the memory for controlling the HVAC system 100 without any need to perform any model reduction or simplifications prior to design of the controller. The RL-based learning system 150 allows us to directly use data, so it reduces or eliminates the need for an expert to design the controller for each new building. The additional benefit of an RL-based controller is that it can use a variety of reward (or cost) functions as the objective to optimize. For instance, it is not anymore limited to quadratic cost functions based on the average temperature in the room. It is also not limited to cost functions that only depend on external factors such as the average temperature as it can easily include the more subjective notions of cost such as the comfort level of occupants.

In some cases, the reinforcement learning determines the value function based on distances between the latest state data and previous state data of the history of the state data.

Another benefit of an RL-based controller is that the controller directly works with a high dimensional, and theoretically infinite-dimensional, state of the system. The temperature or humidity fields, which are observed through multitude of sensors, define a high-dimensional input that can directly be used by the algorithm. This is in contrast with the conventional models that require a low-dimensional representation of the state of the system. The high-dimensional state of the system

can approximately be obtained by placing temperature and airflow sensors at various locations in a room, or be obtained by reading an infrared image of the solid objects in the room. This invention allows various forms of observations to be used without any change to the core algorithm. Working with the high-dimensional state of the system allows higher performing controller compared to those that work with a low-dimensional representation of the state of the system.

Partial Differential Equation Control

Reinforcement learning (RL) is model-free machine learning paradigm concerned with how software agents ought to take actions in an environment so as to maximize some notion of cumulative reward. An environment is a dynamical system that changes according to the behavior of the agent. A cumulative reward is a measure that determines the long-term performance of the agent. Reinforcement learning paradigm allows us to design agents that improve their long-term performance by interacting with their environment.

FIG. 2B shows how an RL agent 220 interacts with its environment 210. At time step t ϵ {1, 2, 3, . . . }, the RL agent 220 observes the state of the environment xₜ 211. It may also partially observe the state, for example, some aspects of the state might be invisible to the agent. The state of the environment is a variable that summarizes the history of the dynamical system. For the HVAC system 100 controlling the temperature of a room or a building, the state of the system is the temperature of each point in the room or a building, as well as the airflow velocity at each point, and the humidity at each point. In some cases, when the state of the system cannot be directly observed, the RL agent 220 observes a function of the state can be observed. For example, the RL agent 220 observes the temperature and humidity at a few locations in the room where sensors are placed. This results in the loss of information. The RL agent 220 can perform relatively well even though the observation does not have all the state information.

After observing a state, or a partial observation of the state, the RL agent 220 selects an action at 221. The action is a command that is sent to the actuators of the HVAC system 100 having a controller. For example, the action can be to increase or decrease the speed of fans, or to increase or decrease the temperature of the air. According to some embodiments of the invention, the computation of the action is performed by the control command 171, which uses the value function outputted by 150.

FIG. 2C shows how the RFQI algorithm is implemented to control the HVAC system 100. The sensors 130 read the current state of the HVAC system. The current state can be referred to as the latest state.

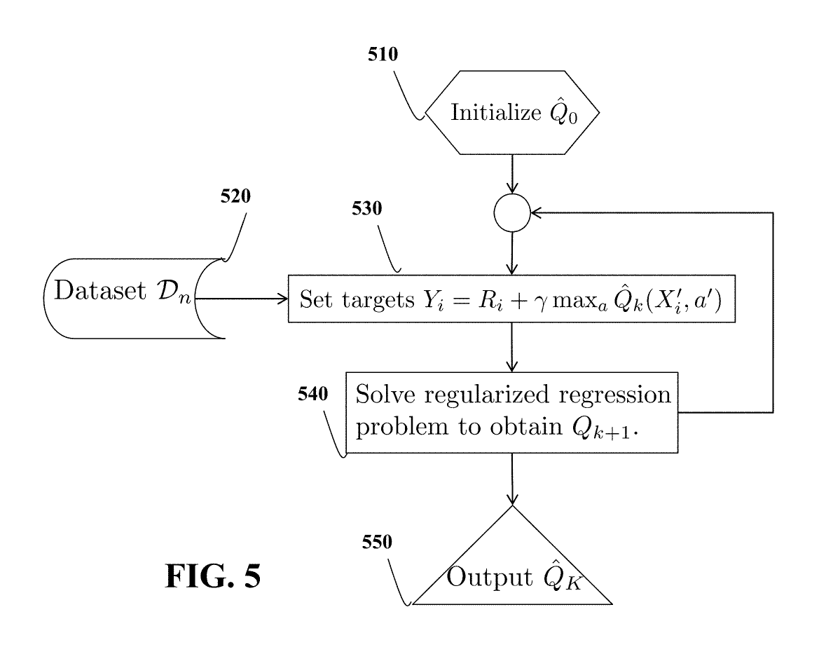

The learning system 150 executes the RFQI algorithm using a processor, a working memory, and some non-volatile memory that stores the program codes. The codes include the code for processing the sensors 130, including the IR sensor. The memory stores the RFQI code 510, 530, 540, 550, the code for action selection 660, and the code for computing the kernel function 450, and a reward function 140. The working memory stores the learned coefficients outputted by the RFQI algorithm 640 as well as the intermediate results. The details are described later with respect to FIG. 5. Through a removable storage 720, the code of RFQI algorithm can be imported to the RFQI Learner 710. The removable storage might be a disk, flash disk, or a connection to a cloud computer.

With respect to FIG. 2B, for a given choice of an action aₜ 221, the state of the environment changes from xₜ to xₜ₊₁. For example, in the HVAC system 100, increasing the temperature of the blown air leads to a change in the temperature profile of the room. In an HVAC system, the dynamics of this change is governed by a set of partial differential equations (PDE), that describe the thermodynamical and fluid dynamics of the room.

Some embodiments of the invention do not need to explicitly know these dynamical equations in order to design the HVAC controller. The RL agent 220 receives the value of a so-called reward function after each transition to a new state 212. The value of the reward function is a real number rₜ that can depend on the state xₜ, the selected action aₜ, and the next state xₜ₊₁.

The reward function determines the desirability of the change from the current state to the next state while performing the selected action. For an HVAC control system, the reward function determines whether the current state of the room is in a comfortable temperature and/or humidity zone to occupants in the room. The reward function, however, does not take into account the long-term effects of the current action and changes in the state. The long-term effects and desirability of an action is encoded in the value function, which is described blow.

Mathematically, an RL problem can be formulated as a Markov Decision Process (MDP). In one embodiment, a finite-action discounted MDP can be used to describe the RL problem. Such MDP is described by a 4-tuple (χ, [symbol] , [symbol] , [symbol] , γ), where χ is an infinite dimensional state space, [symbol] is a finite set of actions, P: χ× [symbol] → [symbol] (χ) is the transition probability kernel, and P: χ× [symbol] → [symbol] ( [symbol] ) is the immediate reward distribution. The constant 0≤γ<1 is the discount factor. Then these quantities are identified within the context of HVAC PDE control.

Consider a domain [symbol] ⊂ [symbol] ³, which might represent inside a room or a building. We denote ∂Z as its boundary, which consists of the walls, the doors, etc. The state of a PDE is described by x ϵ χ. This variable encodes relevant quantities that describe the physical state of the PDE. Examples of these variables are the temperature T: [symbol] → [symbol] and airflow fields v: [symbol] → [symbol] ³.

We consider the control problem in which the PDE is controlled by changing the boundary temperature T_{b}(z, t) and airflow velocity v. For example, in one embodiment of the method, the boundary temperature is changed by turning on/off heaters or coolers, and the airflow is controlled by using fans on the wall and changing the speed.

In the finite-action discounted MDP formulation, the control commands (T_{b} and v) belong to a finite action (i.e., control) set [symbol] with | [symbol] |<∞:

A={(T_{b}^{a}, v^{a}): a=1, . . . , |A|}.

This should be interpreted as choosing action a at time t leads to setting the boundary condition as T_{b}(z, t)=T_{b}^{a}(z) and the velocity flow as v(z, t)=v^{a}(z) for the locations z ϵ Z that can be directly controlled, for example on the boundary ∂Z.

A PDE can be written in the following compact form:

$$\frac{\partial x}{\partial t} = g ( x ( t ) , a ( t ) ) ,$$

in which both the domain and its boundary condition are implicitly incorporated in the definition of the function g. The function g describes the changes in the state of the PDE as a function of the current state x and action a. The exact definition of the function g is not required for the proposed method; we assume that it exists. For example, the function g is a function that can be written by the advection-diffusion and the Navier-Stokes equations.

We discretize the time and work with discrete-time Partial Difference Equations:

xₜ₊₁=f(xₜ, aₜ).

The choice of 1 as the time step is arbitrary and could be replaced by any Δₜ (e.g., second, minute, etc.) but for simplicity we assume it is indeed equal to one. In an HVAC system, this is determined based on the frequency that the HVAC controller might change the actuators.

More generally, one can describe the temporal evolution of the PDE by a transition probability kernel:

Xₜ₊₁˜P(·|Xₜ, aₜ).

We use X instead of x in order to emphasize that it is a random variable. This equation determines the probability of being at the next state Xₜ₋₁ when the current state is Xₜ and the selection action is aₜ. For deterministic dynamics, P(x|X, a)=δ(x−f(X, a)), in which δ is Dirac's delta function that puts a probability mass of unity at f(X, a).

After defining the state space × and the dynamics f: X×A→X (or P for stochastic systems), we specify the reward function r: X×A→ [symbol] . This function evaluates how desirable the current state of the system is as well as how costly the current action is.

In one embodiment, the reward function can be defined as follows. Consider that the comfort zone of people in the room is denoted by Zₚ ⊂ Z, and let T* be the desirable temperature profile. As an example, Zₚ is the area of the room where people are sitting, which is a subset of the whole room. The desired temperature T* might be a constant temperature, or it can be a spatially-varying temperature profile. For instance, in the winter an occupant might prefer the temperature to be warmer wherever an occupant is sitting, while it can be cooler wherever there is none. The reward function 140 can be defined by the following equation

r(x, a)=−[∫_{z}_{ₚ}|T(z)−T*(z)|² dz+c_{action}(α)],

in which c_{action}(a) is the cost of choosing the action. This might include the cost of heater or cooler operation and the cost of turning on the fan.

In some embodiments, other terms can be included. For example, when occupants dislike fan's air to be blown on their body, a cost term can be simply included in the form of −∫_{z}_{ₚ}∥v^{a}(z)∥² to penalize that. In general, we can include any function of x and a in the definition of the reward function. This is in contrast with the conventional approaches that require simple forms such as the quadratic cost function due to its analytical simplicity.

In some embodiments of the invention, the user enters his or her current comfort level through a smartphone application. The reward is provided by the reward function 140.

We now need to define the concept of a policy. The mapping from the state space to an action space π: X→A is called a policy π. Following the policy π in an MDP means that at each time step t, we choose action Aₜ according to Aₜ=π(Xₜ). A policy may also be referred to as a controller.

For a policy π, we define the concept of an action-value function Q^{π}, which is a function of the state and action. The action-value function Q^{π} is a function that indicates that how much discounted cumulative reward the agent obtains if it starts at state x, chooses action a, and after that follows the policy π in its action selection. The value function of the policy π determines the long-term desirability of following π. Formally, let R₁, R₂, R₃, . . . be the sequence of rewards when the Markov chain is started from a state-action (X₁, A₄) drawn from a positive probability distribution over χ×A and the agent follows the policy π. Then the action-value function Q^{π}: χ×A→ [symbol] at state-action (x, a) is defined as

$${Q}^{π} ( x , a ) = E [ {\sum }_{t = 1}^{∞} {γ}^{t - 1} {R}_{t} \vert {X}_{1} = x , {A}_{1} = a ] .$$

For a discounted MDP, we define an optimal action-value function as the action-value function that has the highest value among all possible choices of policies. Formally, it is defined as

$${Q}^{*} ( x , a ) = {sup}_{π} {Q}^{π} ( x , a )$$

for all state-actions (x, a)ϵ X×A.

A policy π* is defined as optimal if the value of the policy achieves the best values in every state, i.e., if Q^{π}*=Q*. The eventual goal of the RL agent 220 is to find the optimal policy π* or a close approximation.

Further, the policy π is defined as greedy with respect to the action-value

$$π ( x ) = {arg max}_{a ∈ A} Q ( x , a )$$

function Q, if for all x ϵ χ.

$$\hat{π} ( x ; Q ) {=}^{Δ} {arg max}_{a ∈ A} Q ( x , a ) , \qquad ( 1 )$$

We define function which returns a greedy policy of the action-value function Q. If there exist multiple maximizers, a maximizer is chosen in an arbitrary deterministic manner. Greedy policies are important because a greedy policy with respect to the optimal action-value function Q* is an optimal policy. Hence, knowing Q* is sufficient for behaving optimally.

The Bellman optimality operator T*: B(χ×A)→B(χ×A) is defined as

$$( {T}^{*} Q ) ( x , a ) {=}^{Δ} r ( x , a ) + γ {\int }_{X} {max}_{{a}^{′}} Q ( y , {a}^{′} ) P ( dy \vert x , a ) .$$

The Bellman optimality operator has a nice property that its fixed point is the optimal value function.

We next describe the RFQI method 150 to find an approximate solution to the fixed-point of the Bellman optimality operator using data. The output of the method is an estimate of the action-value function, which is given to the command generating unit 170. The command generating unit 170 then computes the greedy policy with respect to the estimated action-value function.

Regularized Fitted Q-Iteration

Some embodiments of the invention use a particular reinforcement learning algorithm to find a close to the optimal policy π*. The reinforcement learning algorithm is based on estimating the optimal action-value function when the state x is very high-dimensional. Given such an estimate, a close-to-optimal policy can be found by choosing the greedy policy with respect to the estimated action-value function. For instance, the Regularized Fitted Q-Iteration (RFQI) algorithm can be used.

The RFQI algorithm is based on iteratively solving a series of regression problems. The RFQI algorithm uses a reproducing kernel Hilbert space (RKHS) to represent action-value functions. The RKHS is defined based on a kernel function. The kernel function receives two different states and returns a measure of their “similarity”. The value is larger when two states are more similar.

According to some embodiments of the invention, one can define kernels appropriate for controlling PDEs by considering each high-dimensional state of the PDE as a two, three or more than three-dimensional image. The states can be vectors consisting of pixel values of IR images indicating temperature distribution in a space taken by an IR camera, or scalar numbers related to temperature, humidity or air-flow data obtained by the sensors, or combination of the pixel values of IR images or the numbers related to temperature, humidity or air-flow data. For example, the temperature profile of the room is a 3-dimensional image with the density of each pixel (or voxel or element) corresponding to the temperature. The same also holds for the humidity, and similarly for the airflow. The IR camera includes a thermographic camera or thermal camera. The IR camera provides images showing temperature variations of objects or a zone in a room. The objects include the occupants, desks, chairs, walls, any objects seen from the IR camera. The temperature variations are expressed with predetermined different colors. Each of points in an image provided by the IR camera may include attributes. In this case, the corresponding points of an image or images taken by the IR camera may include attributes. For example, the attributes may include color information. The IR camera outputs or generates images corresponding to pixels indicating temperature information based on predetermined colors and levels of brightness. For instance, a higher temperature area in an image of the IR camera can be red or blight color, and a lower temperature area in the image can be blue or dark color. In other words, each of colors at positions in the image observed by the IR camera represents a predetermined temperature range. Multiple IR cameras can be arranged in the room to observe predetermined areas or zones in the room. The IR cameras take, observe or measure the images at predetermined areas in the room at preset times. The images measured by the identical IR camera provide temperature changes or temperature transitions as a function of time. Accordingly, the difference between the temperature distributions in the room at different time can be input to the controller 105 as different states (or state data) via the data input/output unit 131 according to a predesigned format. The learning system 150 computes the two state data for determining a value function.

In some cases, the latest state data at each point may include one or combination of measurements of a temperature, an airflow, and humidity at the point.

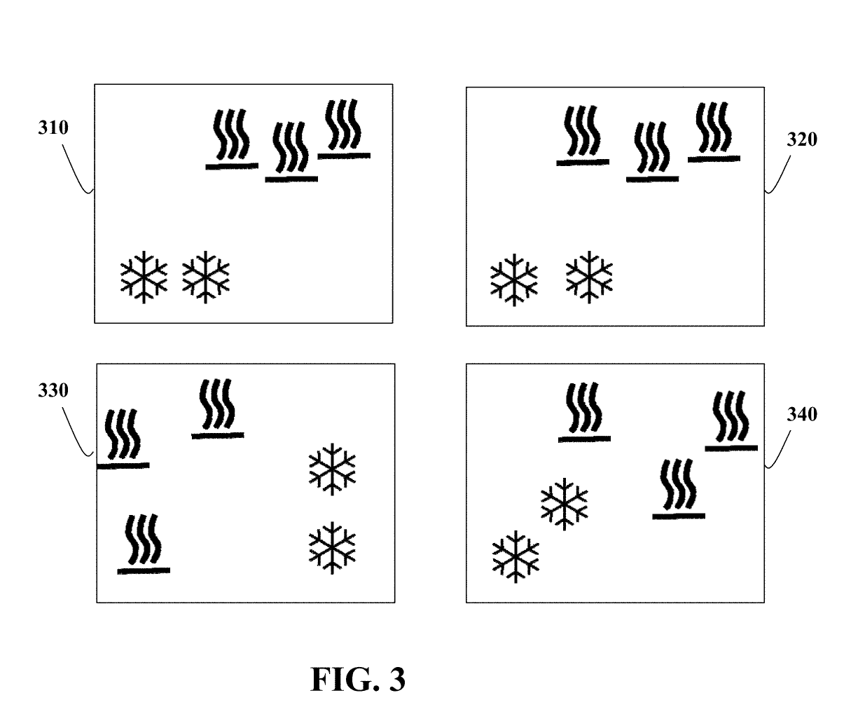

FIG. 3 shows the caricature of several states of a room. In this case, four states (or state data) 310, 320, 330 and 340 are indicated in the figure. The states 310, 320, 330 and 340 can be temperature profiles. Further, the states 310, 320, 330 and 340 can include the airflow and humidity. As an example, the state 310 shows when the top right of a room is warmer than a predetermined temperature and the bottom left is colder than another predetermined temperature. A closely similar state is shown in the state 320. Here the location of cold region is slightly changed, but the overall temperature profile of the room is similar to the state 310. A state 330 shows a different situation compared to the state 310 or the state 320, in which the warm region is concentrated in the left side of the room while the cold region is close to the right side. Another example state is shown in the state 340. Of course, in the real implemented system, we use a real-valued temperature field instead of these caricatures.

Representing the state of the room as an image suggests that we can define a kernel function that returns the similarity of two images. Since the distance between two images can be computed quickly, the RFQI algorithm with aforementioned way of defining kernels can handle very high-dimensional states efficiently.

More concretely, a kernel function K: χ×χ→ [symbol] is a function that receives two states x₁ and x₂, and returns a real-valued number that indicates the similarity between two states. In the HVAC problem, the state might be considered as an image.

The choice of K is flexible. One possible choice is a squared exponential kernel (i.e., Gaussian kernel), which is defined as

$$K ( {x}_{1} , {x}_{2} ) = exp ( - \frac{{‖ {x}_{1} - {x}_{2} ‖}_{X}^{2}}{{σ}^{2}} ) ,$$

in which σ(>0) is a bandwidth parameter and ∥·∥ₓ is a norm defined over the state space. This norm measures a distance between two states x₁ and x₂. Since general states can be vector fields such as temperatures and airflow fields over z , the norm can be potentially infinite dimensional vectors. To define the norm over the vector fields, we consider them similar to (2D or 3D or higher-dimensional) images, as is commonly used in the machine vision technique and compute them as if we are computing the distance between two images.

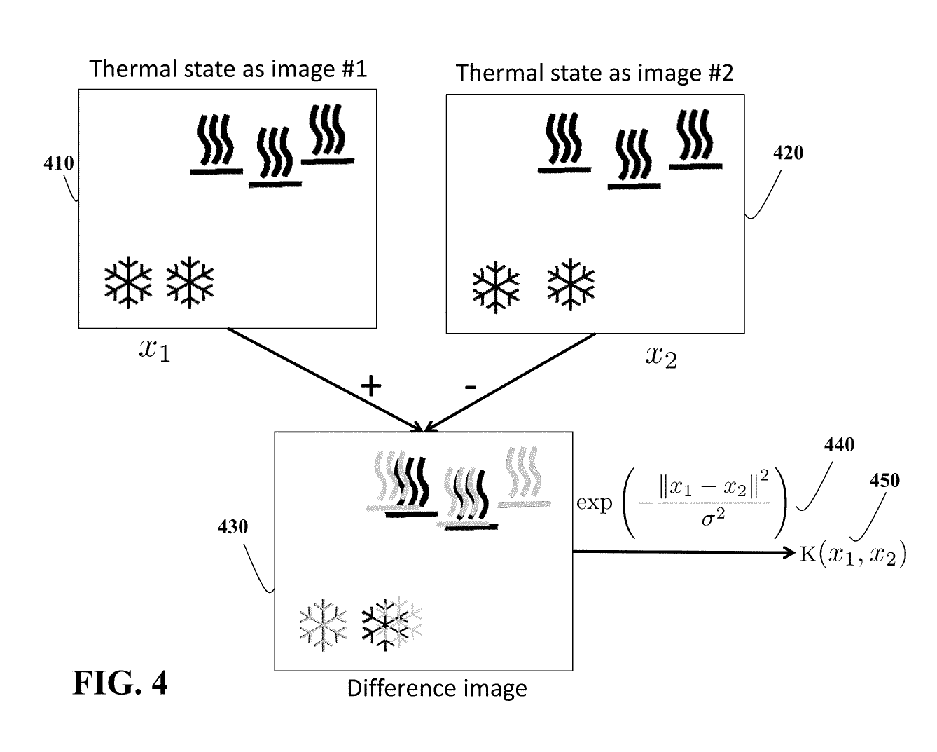

FIG. 4 shows an example of computing the kernel function. Given two images x₁ 410 and x₂ 420, the difference 430 between the images 410 and 420 is computed first. The difference is indicated by an image that shows the difference between two vector fields, treated as images. We then compute the norm of this difference. One embodiment of this norm is the Euclidean norm, which is defined as

$${‖ x ‖}^{2} = {\sum }_{i ∈ Image} {x}^{2} ( i ) ,$$

in which x(i) is an i-th pixel (or voxel or element) in the image x. For a squared exponential kernel, we then compute a deviation value 440 based on the Gaussian kernel,

$$K ( {x}_{1} , {x}_{2} ) = exp ( - \frac{{‖ {x}_{1} - {x}_{2} ‖}_{X}^{2}}{{σ}^{2}} ) ,$$

as indicated in FIG. 4. The outcome 450 after the step of computing 430 is output as K(x₁, x₂). In another embodiment of this work, we may use other similarity distances between two images as the kernel function—as long as they satisfy the technical condition of being a positive semidefinite kernel. We may also use features extracted by a deep neural network to compute the similarities.

In some cases, the distance can be determined by the kernel function using two states corresponding to two images. For instance, when the images are obtained by IR cameras, an image is formed with pixels, and individual pixels include temperature information at corresponding locations in a space taken by the IR camera or IR sensor. The temperature information of a pixel can be a value (number) ranging in predetermined values corresponding to predetermined temperatures. Accordingly, the two images obtained by the IR camera provide two states. By processing the two states with the kernel function, the distance of the two states can be determined.

RFQI Algorithm

The RFQI algorithm is an iterative algorithm that approximately performs value iteration (VI). A generic VI algorithm iteratively performs

Qₖ₊₁←T*Qₖ.

Here Qₖ is an estimation of the value function at the k-th iteration. It can be shown that Qₖ→Q*, that is, the estimation of the value function converges to an optimal action-value function asymptotically.

For MDPs with large state spaces, an exact VI is impractical, because the exact representation of Q is difficult or impossible to obtain. In this case, we can use Approximate Value Iteration (AVI):

Qₖ₊₁≈T*Qₖ,

in which Qₖ₊₁ is represented by a function obtained from a function space F^{|A|}: χ×A→ [symbol] . The function space χ×A can be much smaller than the space of all measurable functions on F^{|A|}. The choice of the function space F^{|A|} is an important aspect of an AVI algorithm, e.g., the function space can be the Sobolev space W^{k}(χ×A). Intuitively, if the AVI T*Qₖ can be well-approximated within F^{|A|}, the AVI performs well.

Additionally, in the HVAC control system, especially when we only have data (RL setting) or the model is available with much complexity, the integral in the AVI T*Qₖ cannot be computed easily. Instead, one only has a sample X′ᵢ˜P(·|Xᵢ, Aᵢ) for a finite set of state-action pairs {(Xᵢ, Aᵢ)}ᵢ₌₁ⁿ. In the HVAC control system, Xᵢ might be a snapshot of the temperature and airflow field. It can be measured using multitude of spatially distributed temperature and airflow sensors 130. Another embodiment is that one uses Infrared sensors to measure the temperature on solid objects.

Note that for any fixed function Q,

$$E [ R ( x , a ) + γ {max}_{{a}^{′} ∈ Å} Q ( {X}^{′} , {a}^{′} ) \vert X = x , A = a ] = ( T * Q ) ( x , a ) ,$$

that is, the conditional expectation of samples in the form of

$$r ( x , a ) + γ {max}_{{a}^{′} ∈ Å} Q ( {X}^{′} , {a}^{′} )$$

is indeed the same as T*Qₖ. Finding this expectation is the problem of regression. The RFQI algorithm is an AVI algorithm that uses regularized least-squares regression estimation for this purpose.

The RFQI algorithm works as follows, as schematically shown in FIG. 5. At the first iteration, the RFQI algorithm starts with initializing the action-value function \hat{Q}₀ 510. The action-value function \hat{Q}₀ can be initialized to zero function or to some other non-zero function, if we have a prior knowledge that the optimal action-value function would be close to the non-zero function. The non-zero initial function can be obtained from solving other related HVAC control tasks in the multi-task reinforcement learning setting.

At iteration k, we are given a dataset Dₙ={(Xᵢ, Aᵢ, Rᵢ, X′ᵢ)}ᵢ₌₁ⁿ 520. Here Xᵢ is a sample state, the action Aᵢ is drawn from π_{b}(·|Xᵢ), a behavior policy, the reward Rᵢ˜R(·|Xᵢ, Aᵢ), and the next state X′ᵢ˜P(·|Xᵢ, Aᵢ). In the HVAC system, these data are collected from the sensors 130, the control commands (or command signals) 171 applied to the HVAC system 100, and the reward function 140 providing a reward value. The collection of the data can be done before running the RL algorithm or during the working of the algorithm.

For the RKHS algorithm, we are also given a function space F^{|A|}=H: χ×A→R corresponding to a kernel function K: (χ×A)×(χ×A)→R. For any Xᵢ, we set the target of regression as Yᵢ=Rᵢ+γ maxₐ\hat{Q}ₖ(X′ᵢ, a′) 530, and solve the regularized least squares regression problem 540. That is, we solve the following optimization problem:

$${\hat{Q}}_{k + 1} ← {arg min}_{Q ∈ H} \frac{1}{n} {\sum }_{i = 1}^{n} {\vert Q ( {X}_{i} , {A}_{i} ) - [ {R}_{i} + γ {max}_{{a}^{′} ∈ Å k} \hat{Q} ( {X}_{i}^{′} , {a}^{′} ) ] \vert}^{2} + λ {‖ Q ‖}_{H}^{2} . \qquad ( 2 )$$

The function space H, being a Hilbert space, can be infinite dimensional. But for Hilbert spaces that have the reproducing kernel property, one can prove a representative theorem stating that the solution of this optimization problem has a finite representation in the form of

$${\hat{Q}}_{k + 1} ( x , a ) = {\sum }_{i = 1}^{n} {α}_{i}^{( k + 1 )} K ( ( {X}_{i} , {A}_{i} ) , ( x , a ) ) , \qquad ( 3 )$$

for some vector α^{(k+1)}=(α₁^{(k+1)}, . . . ^{(k+1)}, αₙ^{(k+1})^{T} ϵ Rⁿ. Here K((Xᵢ, Aᵢ), (x, a)) is the similarity between the state-action (x, a) and (Xᵢ, Aᵢ). The kernel here is defined similar to how it was discussed before and shown in FIG. 4, with the difference that the state-action (as opposed to only states) are compared. In one embodiment, we define

K((x₁, a₁), (x₂, a₂))=K(x₁, x₂)II{a₁=a₂}.

We already discussed the choice of kernel function K(x₁, x₂) for one embodiment of the invention.

Since the RFQI algorithm works iteratively, it is reasonable to assume that \hat{Q}ₖ has a similar representation (with α^{(k)} instead of α^{(k+1)}). Moreover, assume that the initial value function is zero, i.e., \hat{Q}₀=0. We can now replace Q and \hat{Q}ₖ by their expansions. We use the fact that for Q(x, a)=Σᵢ₌₁ⁿαᵢK((Xᵢ, Aᵢ), (x, a)), ∥Q∥_{H}²=α^{T}Kα, with K being the Grammian matrix to be defined shortly. After some algebraic manipulations, we get that the solution of (2) is

$${α}^{( k + 1 )} = \{ \begin{matrix}{( K + n λ I )}^{- 1} r & k = 0 , \\ {( K + n λ I )}^{- 1} ( r + γ {K}_{k}^{+} {α}^{( k )} ) & k \geq 1.\end{matrix} \qquad ( 4 )$$

Here r=(R₁, . . . , Rₙ)^{T}. To define K, Kₖ⁺ ϵ R^{n×n}, first define

$${A}_{i}^{* ( k )} = arg {max}_{{a}^{′} ∈ A} {\hat{Q}}_{k} ( {X}_{i}^{′} , {a}^{′} ) , i . e . ,$$

the greedy action with respect to \hat{Q}ₖ at the next-state X′ᵢ. We then have

[K]ᵢⱼ=K((Xᵢ, Aᵢ), (Xⱼ, Aⱼ))

[Kₖ⁺]ᵢⱼ=K((X′ᵢ, A*ᵢ^{(k)}), (Xⱼ, Aⱼ)).

This computation is performed for K iterations. After that, the RFQI algorithm returns \hat{Q}_{K} 550.

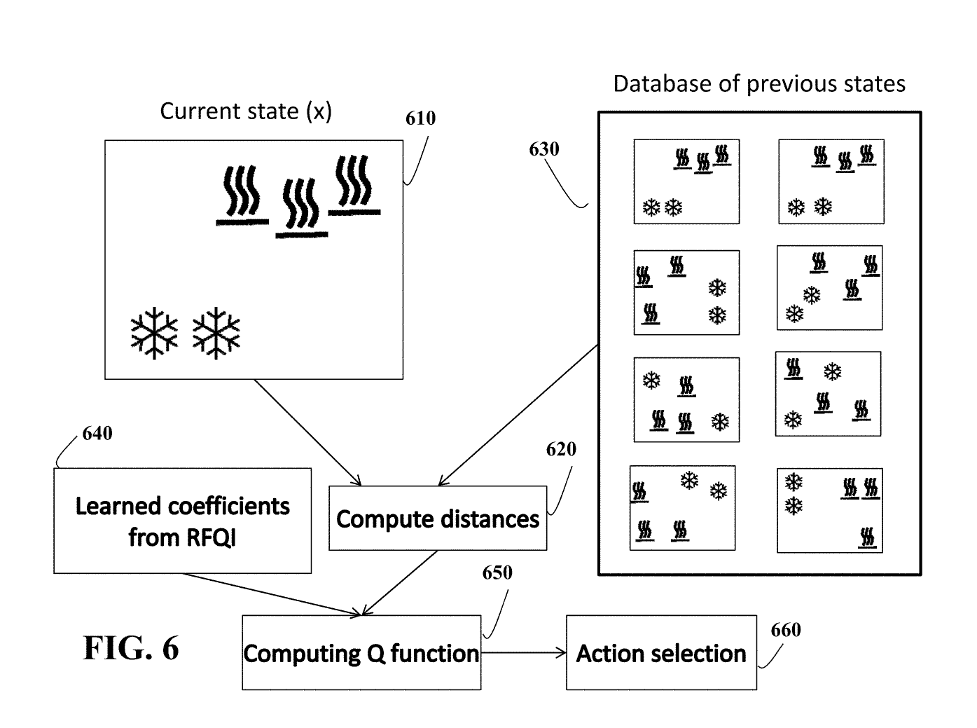

FIG. 6 shows how to select an action given a new state x. When a new state x 610 is given by the multitude of sensors that observe the state of the HVAC system 130, a similarity 620 is computed with respect to all previously observed state-actions in the dataset Dₙ 630. We then use the coefficients α^{(K)} obtained by (4), shown in 640, along with the pairwise similarities 620, to compute \hat{Q}_{K} (x, a) 650 for all a ϵ A using (3). The selected action 660 is chosen using the greedy policy (1) with respect to \hat{Q}_{K}, that is

$$α = \hat{π} ( x ; {\hat{Q}}_{K} ) = arg {max}_{a ∈ Å} {\hat{Q}}_{K} ( x , a ) = arg {max}_{a ∈ Å} {\sum }_{i = 1}^{n} {α}_{i}^{( K )} K ( ( {X}_{i} , {A}_{i} ) , ( x , a ) ) .$$

This determines the action as the control command 171. The control command 171 is transmitted to the actuator control unit 180 to generate the control signals 181 for the actuators of the HVAC system. This algorithm can continually collect new data and update \hat{Q} to improve the policy, without any need for human intervention. The embodiments are not limited to the regularized least-squares regression and the RFQI algorithm. One may use other regression methods that can work with a similarity distance between images. In some embodiments of the invention, one may use a deep neural network as the representation of the \hat{Q} function.

In another embodiment, a convolutional deep neural network is used to process the input from the infrared camera. At each iteration of the said method, we use a deep convolutional neural network to fit the data by solving the following optimization problem:

$${\hat{Q}}_{k + 1} ← {arg min}_{Q ∈ DNN} \frac{1}{n} {\sum }_{i = 1}^{n} {\vert Q ( {X}_{i} , {A}_{i} ) - [ {R}_{i} + γ {max}_{{a}^{′} ∈ Å} {\hat{Q}}_{k} ( {X}_{i}^{′} , {a}^{′} ) ] \vert}^{2} .$$

The optimization does not need to be done exactly, and one may use a stochastic gradient descent or some other parameter tuning algorithm to update the weights of the neural network. In the said DNN implementation, the convolutional layer of the network process the image-like input, which is in the form of IR sensors. Other sensors might also be added.

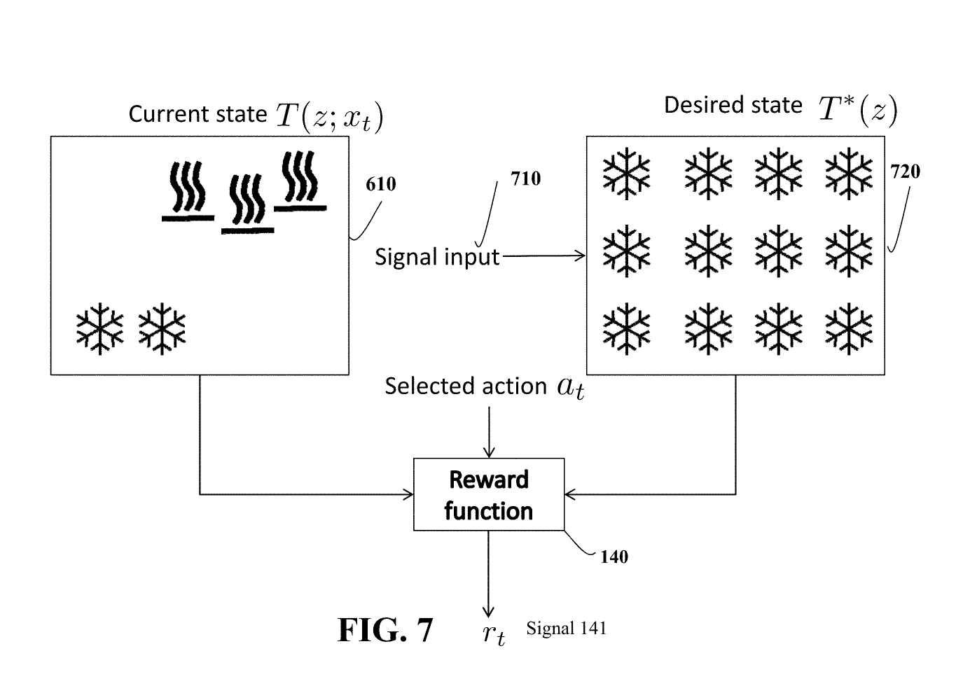

FIG. 7 shows an example of a procedure for computing a reward function 140. At each time step, the sensors 130 observe the current temperature of the room 610. The sensors 130 include IR sensors or some other temperature sensor arranged in the room 160.

A signal 710 regarding a preferred temperature is input to the HVAC system 100. The signal 710 may be a scalar value relevant to a temperature signal received from a thermostat. In some embodiments, the command signal 710 may be input through a mobile application of a smart phone, or through a web-based interface. The temperature can be a single number, or can be specified as different temperatures in different regions of the room 160. Desired temperatures at predetermined points in the room 160 are stored in a memory as a vector field 720. The desired temperature can be inferred from a single number entered by a user using an input device. The input device may be some other means. For instance, the input device may be a voice recognition system installed in the sensors 130 in the room 160. When the voice recognition system recognized a preferred temperature of the occupant, the voice recognition system of the sensor 130 transmits a signal associated with a desired temperature recognized from a spoken language of the occupant to the HVAC system 100.

The reward function computes the reward value 141 according to equation (1). This procedure may be referred to as a reward metric.

As described above, a controlling method of an air-conditioning system conditioning an indoor space includes steps of measuring, by using at least one sensor, state data of the space at multiple points in the space, storing a history of the state data and a history of control commands having been applied to the air-conditioning system, wherein the history of the control commands is associated with the state data and history of rewards, determining a value function outputting a cumulative value of the rewards, wherein the determining the value function is performed by using a reinforcement learning algorithm that processes the histories of the state data, control commands, and reward data, determining a control command based on the value function using latest state data and the history of the state data; and controlling the air-conditioning system by using at least one actuator according to the control command.

Further the steps of the method described above can be stored in a non-transitory computer readable recoding medium storing as a program having instructions. When the program is executed by a computer or processor, the program causes the computer to execute the instructions for controlling an air-conditioning system air-conditioning an indoor space, the instructions comprising steps of measuring, by using at least one sensor, state data of the space at multiple points in the space, storing a history of the state data and a history of control commands having been applied to the air-conditioning system, wherein the history of the control commands is associated with the state data and history of rewards, determining a value function outputting a cumulative value of the rewards, wherein the determining the value function is performed by using a reinforcement learning algorithm that processes the histories of the state data, control commands, and reward data and transmits a control command, determining a control command based on the value function using latest state data and the history of the state data, and controlling the air-conditioning system by using at least one actuator according to the control command.

Further, in some embodiments, the air-conditioning system conditioning an indoor space includes at least one sensor configured to measure state data of the space at multiple points in the space, an actuator control device comprises: a compressor control device configured to control a compressor; an expansion valve control device configured to control an expansion valve; an evaporator fan control device configured to control an evaporator fan, a condenser fan control device configured to control a condenser fan; and a controller configured to transmit a control command to the actuator control device, wherein the controller comprises: a data input to receive state data of the space at multiple points in the space; a memory to store a code of a reinforcement learning algorithm and a history of the state data and a history of control commands having been applied to the air-conditioning system, wherein the history of the control commands is associated with the state data and history of rewards; a processor coupled to the memory determines a value function outputting a cumulative value of the rewards and transmits a control command by using the reinforcement learning, wherein the reinforcement learning processes the histories of the state data, control commands, and reward data and transmits a control command; a data output to receive the control command from the processor and transmit a control signal to the air-conditioning system, wherein the control signal controls at least one actuator of the air-conditioning system according to the control command.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

We claim:

1. A controller for operating an air-conditioning system conditioning an indoor space, the controller comprising:
a data input to receive state data of the space at multiple points in the space;
a memory to store a code of a reinforcement learning algorithm and a history of the state data and a history of control commands having been applied to the air-conditioning system, wherein the history of the control commands is associated with the state data and history of rewards;
a processor coupled to the memory determines a value function outputting a cumulative value of the rewards and transmits a control command by using the reinforcement learning algorithm, wherein the reinforcement learning algorithm processes the histories of the state data, control commands, and reward data and transmits a control command;
a data output to receive the control command from the processor and transmit a control signal to the air-conditioning system, wherein the control signal controls at least one actuator of the air-conditioning system according to the control command.

2. The controller of claim 1, wherein the latest state data at each point include one or combination of measurements of a temperature, an airflow, and humidity at the point.

3. The controller of claim 1, wherein the sensor is an infrared (IR) sensor measuring a temperature on a surface of an object in the space.

4. The controller of claim 1, wherein the object is a wall forming the space.

5. The controller of claim 1, wherein the reinforcement learning algorithm determines the value function based on distances between the latest state data and previous state data of the history of the state data.

6. The controller of claim 5, wherein the distance is determined by a kernel function using two states corresponding to two images.

7. The controller of claim 1, wherein the reinforcement learning algorithm is performed based a Regularized Fitted Q-Iteration (RFQI) algorithm.

8. The controller of claim 1, wherein each of the state data is an IR image indicating a temperature distribution in the space.

9. The controller of claim 1, wherein each of the state data is formed of pixel data of an IR image measured by said at least one sensor.

10. The controller of claim 1, wherein said at least one sensor includes a microphone and a voice recognition system.

11. A controlling method of an air-conditioning system conditioning an indoor space, the method comprising steps of:
measuring, by using at least one sensor, state data of the space at multiple points in the space;
storing a history of the state data and a history of control commands having been applied to the air-conditioning system, wherein the history of the control commands is associated with the state data and history of rewards;
determining a value function outputting a cumulative value of the rewards, wherein the determining the value function is performed by using a reinforcement learning algorithm that processes the histories of the state data, control commands, and reward data and transmits a control command;
determining a control command based on the value function using latest state data and the history of the state data; and
controlling the air-conditioning system by using at least one actuator according to the control command.

12. The controlling method of claim 11, wherein the latest state data at each point include one or combination of measurements of a temperature, an airflow, and humidity at the point.

13. The controlling method of claim 11, wherein said at least one sensor is an infrared (IR) sensor measuring a temperature on a surface of an object in the space.

14. The controlling method of claim 11, wherein the object is a wall forming the space.

15. The controlling method of claim 11, wherein the reinforcement learning algorithm determines the value function based on a distance between the latest state data and the history of state data.

16. The controlling method of claim 15, wherein the distance is determined by a kernel function between two states corresponding to two images formed by state variables of the two states.

17. The controlling method of claim 11, wherein the reinforcement learning algorithm is performed based a Regularized Fitted Q-Iteration (RFQI) algorithm.

18. A non-transitory computer readable recording medium storing thereon a program having instructions, when executed by a computer, the program causes the computer to execute the instructions for controlling an air-conditioning system air-conditioning an indoor space, the instructions comprising steps of:
measuring, by using at least one sensor, state data of the space at multiple points in the space;
storing a history of the state data and a history of control commands having been applied to the air-conditioning system, wherein the history of the control commands is associated with the state data and history of rewards;
determining a value function outputting a cumulative value of the rewards, wherein the determining the value function is performed by using a reinforcement learning algorithm that processes the histories of the state data, control commands, and reward data and transmits a control command;
determining a control command based on the value function using latest state data and the history of the state data; and
controlling the air-conditioning system by using at least one actuator according to the control command.
